(19) United States
(12) Patent Application Publication
(10) Pub. No.: US 2014/0291170 A1
(43) Pub. Date: Oct. 2, 2014

(54) ETHYLENE GAS DETECTION DEVICE AND METHODS OF USE

(71) Applicant: CID Bio-Science, Inc., Camas, WA (US)

(72) Inventors: James R. Goecks, Camas, WA (US); Ryan M. Lerud, Portland, OR (US)

(73) Assignee: CID Bio-Science, Inc., Camas, WA (US)

(21) Appl. No.: 14/185,136

(22) Filed: Feb. 20, 2014

Related U.S. Application Data
(60) Provisional application No. 61/807,675, filed on Apr. 2, 2013.

(51) Int. Cl. G01N 27/416

(52) U.S. Cl. CPC G01N 27/4162
USPC 205/787; 204/402; 204/431

(57) ABSTRACT

Provided herein are methods, apparatuses, and systems for enhancing the detection of reactive gases, such as ethylene gas, that are present at low concentrations in air samples. The methods and systems enhance the selectivity, sensitivity, and accuracy of electrochemical cells by removing interfering gases from the air samples. Some systems include an ethylene sensor that includes an electrochemical cell and a polar solvent gas trap pre-filter, wherein the gas trap is positioned upstream of the electrochemical cell. Some methods are methods of measuring an ethylene level in an air sample, and include passing the air sample by through a polar solvent gas trap, and measuring the ethylene level in the air sample with an electrochemical cell.

### CROSS REFERENCE TO RELATED APPLICATION

The present application claims priority to U.S. Provisional Patent Application No. 61/807,675, filed Apr. 2, 2013, entitled “ETHYLENE GAS SEPARATION METHOD,” the disclosure of which is hereby incorporated by reference in its entirety.

### TECHNICAL FIELD

Embodiments herein relate to the detection of low concentrations of reactive gases, and more particularly, to methods and devices for enhancing the accuracy, selectivity, and/or sensitivity of ethylene gas sensors.

### BACKGROUND

Ethylene is a classical plant hormone involved in fruit abscission and ripening. Maintaining low ethylene concentrations in a storage environment allows some major commodities (such as certain fruits and cut flowers) to be harvested before physiological maturity and then stored and/or transported to distant markets. High ethylene levels can lead to premature development, spoilage, and ultimately economic loss in these scenarios. Inexpensive, effective, and portable electrochemical ethylene sensors with sufficient selectivity have been elusive.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIGS. 1A and 1B include a photograph of an example of an ethylene sensor, an Interscan™ electrochemical cell, (FIG. 1A), and a schematic diagram of an exemplary electrochemical cell (FIG. 1B), for use in accordance with various embodiments;

FIG. 2 is a schematic diagram of an exemplary gas trap for use with an ethylene sensor, such as the ethylene sensors of FIGS. 1A and 1B, in accordance with various embodiments;

FIG. 3 is a schematic diagram illustrating how the gas trap of FIG. 2 may be regenerated by switching into an internal closed loop, in accordance with various embodiments; and

FIG. 4 is a graph showing measured ethylene and “pseudo-ethylene” concentrations after utilizing a gas trap to filter the analyte airstream, in accordance with various embodiments.

### DETAILED DESCRIPTION

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, methods, apparatuses, and systems are provided for enhancing the detection of reactive gases, such as ethylene gas, that are present at low concentrations. In exemplary embodiments, a computing system may be endowed with one or more components of the disclosed apparatuses and/or systems and may be employed to perform one or more methods as disclosed herein.

Ethylene, a classical plant hormone, is a small molecule, colorless hydrocarbon gas composed of two carbon atoms and four hydrogen atoms (C₂H₄ or H₂C═CH₂). Ethylene is responsible for both beneficial and undesirable effects in ornamental plants and food crops. For instance, ethylene can prevent flowering, shorten internode length, increase branching, initiate fruit ripening, trigger leaf and flower senescence and abscission, cause leaf chlorosis (yellowing), and improve adventitious rooting. Some crops are relatively insensitive to ethylene, while others are very sensitive. For example, Poinsettia shows little change after a 24 hour 1 part per million (ppm) ethylene exposure, yet Cuphea hyssopifolia abscises all flowers after a 24 hour 0.01 ppm exposure.

It is important to limit ethylene levels in many commercial settings, such as greenhouses and produce warehouses, because the gas may affect many fruits and flowers by hastening floral senescence and abscission and fruit ripening. Therefore, ethylene may shorten the shelf life of fruit, cut flowers, if not carefully controlled. Additionally, produce, flowers, and plants that are subjected to stress during shipping, handling, or storage may produce excess ethylene, further reducing shelf life and floral display. Maintaining low ethylene concentrations in a storage environment allows some major commodities (such as bananas, citrus, and cut flowers) to be harvested before physiological maturity and then stored and/or transported to distant markets. Ethylene leakage into or accumulation in such storage containers can lead to premature development, spoilage, and ultimately economic loss.

Thus, ethylene can cause significant economic losses for florists, markets, suppliers, and growers. At the same time, ethylene can be commercially useful, for instance in inducing fruit ripening at the point of sale, and in inducing certain plants to flower, such as bromeliads and pineapple plants. Thus, the detection and monitoring levels of ethylene in the environment may be helpful in a wide variety of settings.

Ethylene detection typically has been carried out using gas chromatography. However, this approach can be expensive, and generally is not suitable for real-time field use. Electrochemical sensors are portable and affordable, but achieving sufficient accuracy, selectivity, and sensitivity has been problematic. Ethylene typically is present at low concentrations in any air sample, and other interfering gases may reduce the efficacy of many ethylene sensors. However, as described herein in greater detail below, sensitivity, selectivity, and accuracy may be improved if the analyte air is pre-filtered to remove gases that may interfere with ethylene detection.

Electrochemical ethylene sensors are detectors that measure an ethylene gas concentration by oxidizing ethylene at an electrode and measuring the resulting current. Typical sensors contain two, three, or four electrodes that contact an electrolyte. In some embodiments, the electrodes may be fabricated by fixing a high surface area precious metal on a porous hydrophobic membrane. In some embodiments, the working electrode may contact both the electrolyte and the air to be monitored, for instance, via the porous membrane. The electrolyte most commonly used is a mineral acid, but organic electrolytes are also used in some embodiments.

In various embodiments, an air sample may diffuse into or be circulated though the sensor housing to the working electrode, where the ethylene gas contained in the sample is oxidized. In various embodiments, this electrochemical reaction results in an electric current that passes through an external circuit. In some embodiments, in addition to measuring, amplifying, and performing other signal processing functions, the external circuit may maintain the voltage across the sensor between the working and counter electrodes for a two-electrode sensor, or between the working and reference electrodes for a three electrode sensor. In various embodiments, an equal and opposite reaction (e.g., a reduction) may occur at the counter electrodes.

Generally speaking, the magnitude of the current is controlled by how ethylene is oxidized at the working electrode. However, as described above, ethylene typically is present at low concentrations in any air sample, and other interfering gases may reduce the efficacy of many electrochemical sensors. As used herein, the term “interfering gas” refers to any gas that oxidizes in the same potential window as ethylene. For instance, in some embodiments, the potential window is between about 0.4 volts and about 0.6 volts. In various embodiments, this cross sensitivity may be a problem because ethylene requires a very active working electrode catalyst and high operating potential for its oxidation. Therefore, in various embodiments, gases that are more easily oxidized, such as alcohols and carbon monoxide, will also generate a sensor signal. In various embodiments, the primary interfering gases in field applications may be ethanol and isoamyl acetate.

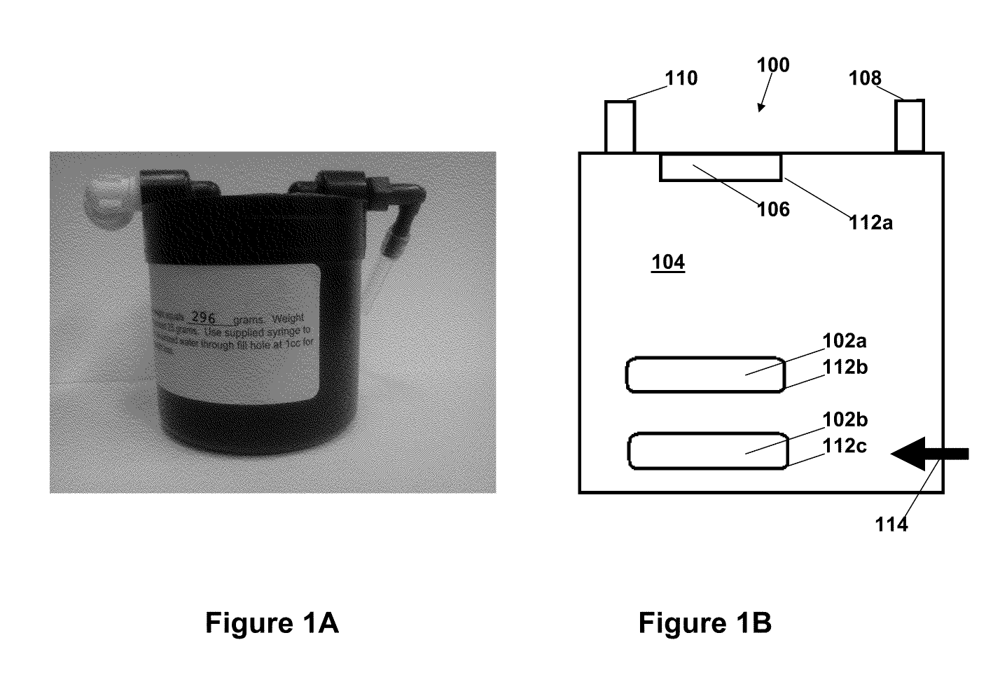

One example of an electrochemical cell for detecting ethylene is illustrated in FIGS. 1A and 1B, which include a photograph of an Interscan™ electrochemical cell (Ashtead Technology, Windson, N.J.), (FIG. 1A), and a schematic diagram of an exemplary electrochemical cell (FIG. 1B), for use in accordance with various embodiments. As shown in FIG. 1B, an electrochemical cell 100 may include a pair of lead dioxide counter electrodes 102a, 102b, an electrolyte 104 supported in a substrate, such as glass wool, a working electrode 106, such as a platinum electrode, an analyte air flow inlet 108, a gas exhaust outlet 110, electrical lead contacts 112a, 112b, and 112c, and an electrolyte fill hole 114. In use, in various embodiments, an appropriate amount of an appropriate electrolyte may be introduced to electrical cell 100 via electrolyte fill hole 114, and an air sample may be introduced to electrochemical cell 100 via air flow inlet 108. The air sample may then pass over working electrode 106, where any ethylene gas (and any interfering gases) oxidize and generate an electrical signal. In various embodiments, an opposing reducing reaction may occur at lead dioxide counter electrodes 102a, 102b. In various embodiments, the air sample may then exit electrochemical cell 100 via gas exhaust outlet 110. In various embodiments, the electric current generated by the oxidation may then pass through an external circuit (not shown), and it may then be subjected to various amplification and signal processing functions in order to generate an output signal corresponding to the level of ethylene gas (and other interfering gases) in the sample. These signal processing steps are conventional, and will be familiar to those of skill in the art. In some embodiments, the leads extending from the counter electrodes join and form a single lead.

As described above, certain interfering gases in the air sample may cause the electrochemical cell to generate an erroneous reading. However, as disclosed herein, a gas trap may be used to remove interfering gases from the air sample before it enters the electrochemical cell, thus enhancing the sensitivity, selectivity, and accuracy of the ethylene sensor. In various embodiments, the gas trap may make use of ethylene's relative lack of solubility in polar solvents, as compared to the interfering gases that may be present in the air sample. In some embodiments, the air sample may be bubbled through a water-filled or alcohol-filled conditioning chamber prior to introduction into the ethylene sensor, which results in effective removal of several interfering gases, including ethanol, methanol, and isomyl acetate. Although water is used in various specific embodiments described herein, other polar solvents also may be used, such as ammonia, either alone or in combination with water. In various embodiments, the gas trap employs the chemistry principle of “like dissolves like,” and polar molecules such as ethanol, methanol, and isomyl acetate are removed by the trap. In various embodiments, ethylene, a nonpolar hydrocarbon, may pass through the trap with relative ease. Thus, in various embodiments, the operational performance of various ethylene sensors may be improved using the methods and devices described herein. In particular embodiments, large improvements may be seen in sensor selectivity when he gas trap is used as an upstream pre-filter for the air sample.

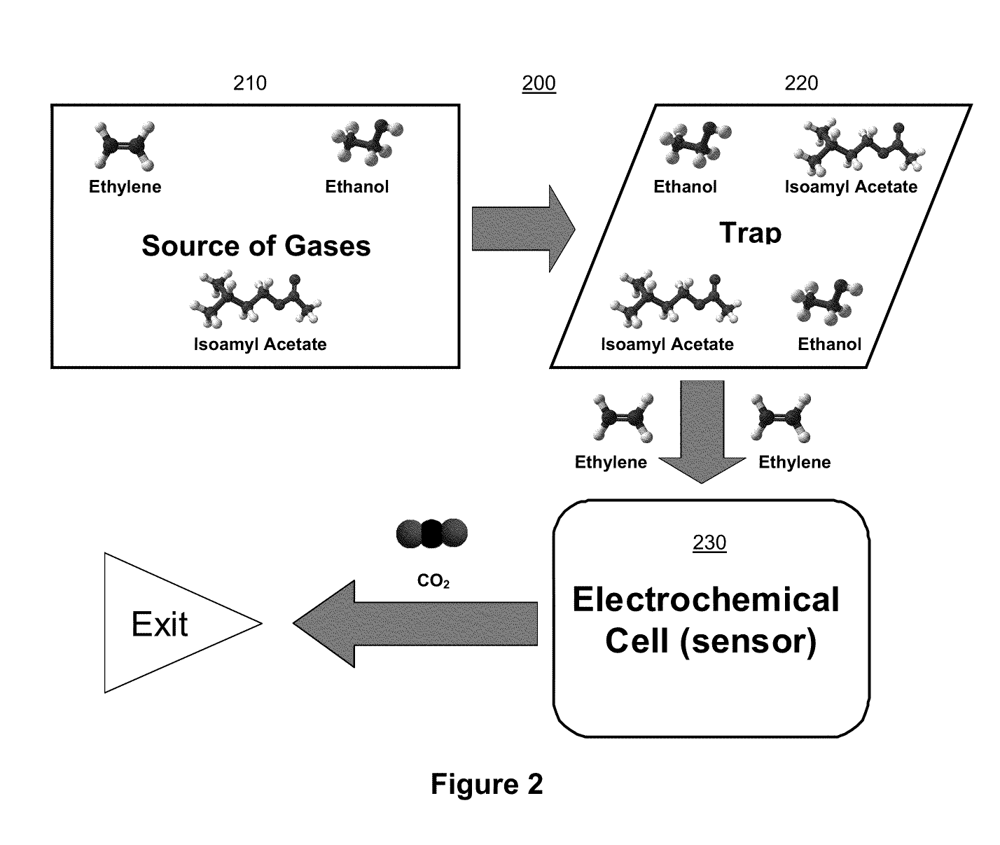

FIG. 2 is a schematic diagram of an exemplary gas trap system 200 for use with an ethylene sensor, such as the electrochemical cell depicted in FIG. 1B, in accordance with various embodiments. As shown in FIG. 2, the source of gases 210 (e.g., environmental air samples) may include both ethylene and interfering gases, such as ethanol and isoamyl acetate. In various embodiments, these interfering gases may cause erroneous readings from an electrochemical cell. Thus, in various embodiments, the air sample may be passed through gas trap 220, wherein polar molecules, such as ethanol and isoamyl acetate, are dissolved in the polar solvent of gas trap 220. By contrast, in various embodiments, ethylene passes through gas trap 220 to the electrochemical cell sensor 230, where oxidation occurs, releasing CO₂ as the oxidation product. Because interfering gases remain in gas trap 220 and do not enter the electrochemical cell sensor 230, the sensor output is reflective of the level of ethylene in the air sample, and is not artifactually elevated by the presence of interfering gases.

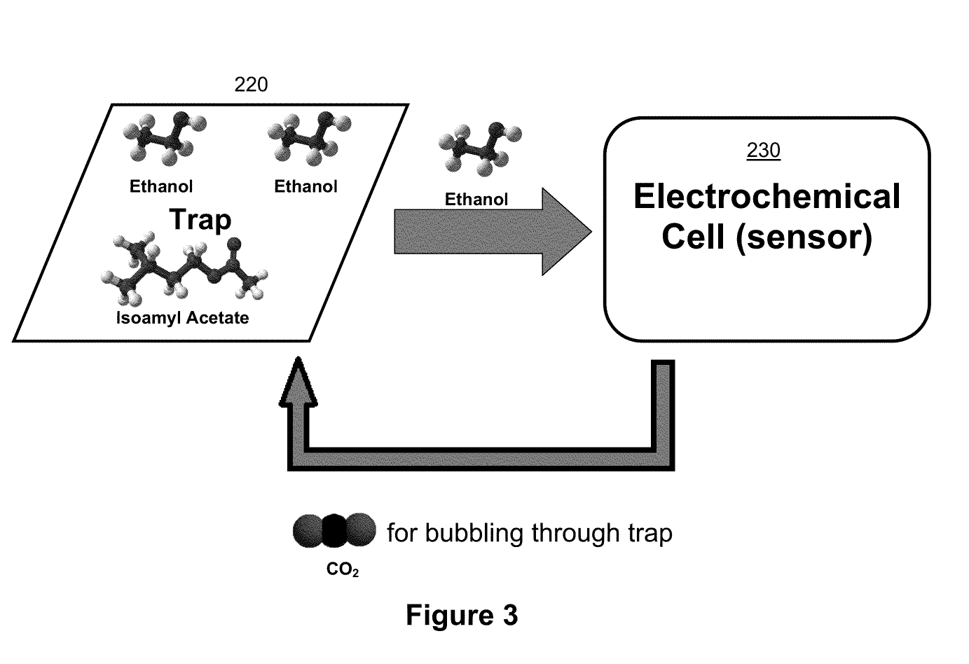

In some embodiments, following use, the gas trap may be regenerated by reversing the concentration gradient between the trap and the analyte air stream. FIG. 3 is a schematic diagram illustrating how the gas trap of FIG. 2 may be regenerated by switching into an internal closed loop, in accordance with various embodiments. In various embodiments, after use, the output of electrochemical cell sensor 230 may have a lower concentration of interfering gases than those trapped in gas trap 220. In various embodiments, this gradient may lead to migration of the trapped interfering gases to the vapor phase, where they are oxidized and/or burned in electrochemical cell sensor 230. In various embodiments, after a sufficiently low concentration of interfering gas molecules is detected in gas trap 220, the electrochemical cell sensor 230 may return to normal operational conditions.

EXAMPLES

### Example 1

### Validation Testing of the Gas Trap

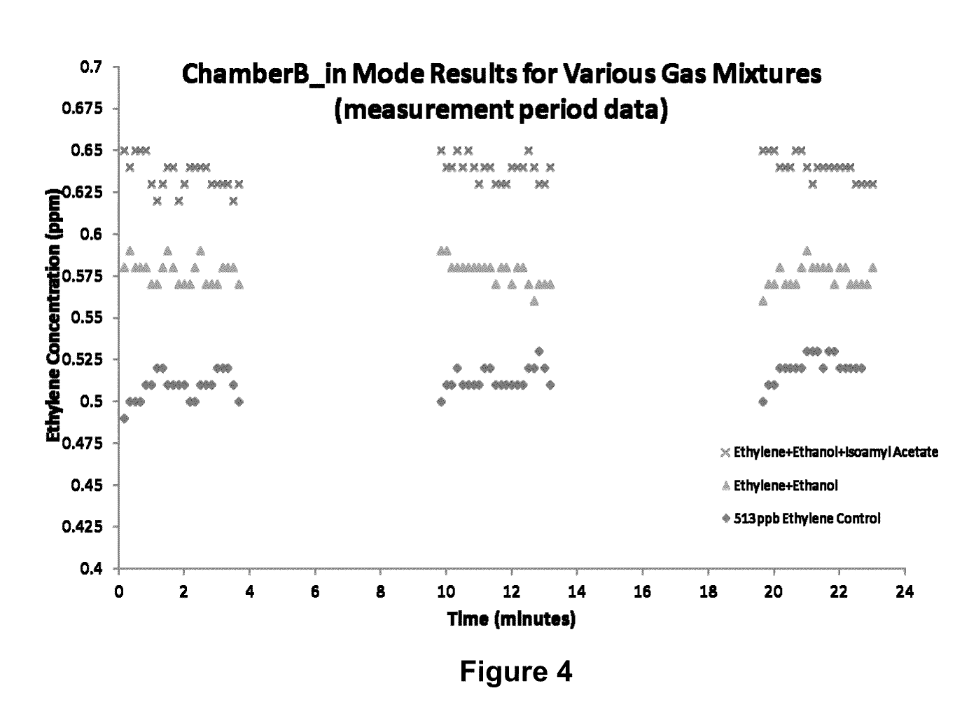

This Example demonstrates the efficacy of the gas trap described herein in removing interfering gases from an air sample prior to measurement of ethylene levels in the air sample, thereby increasing the sensitivity, accuracy, and selectivity of the ethylene sensor. FIG. 4 is a graph showing measured ethylene and “pseudo-ethylene” concentrations after utilizing a gas trap to filter the analyte airstream, in accordance with various embodiments. The reference data (e.g., the control, shown as diamonds in FIG. 4) were collected by connecting a Cl-900 electrochemical cell ethylene sensor (ClD Bio-Science, Camas, Wash.)directly to a 513 parts per billion (ppb) ethylene calibration source. To test the effect of interfering gases, two 3 liter sample bags were filled with 513 ppb ethylene from the calibrated source. For the “ethanol interfering data” (shown as triangles in FIG. 4), each sample bag was injected with 5 milliliters of head space from an 82% bottle of ethanol. This procedure was repeated for the mixture of isoamyl acetate and ethanol (shown as x's in FIG. 4), and the sample bag was injected with 5 milliliters of head space from a 99% bottle of isoamyl acetate and 5 milliliters of ethanol headspace from the above-mentioned ethanol bottle.

As shown in FIG. 4, when the gas trap was employed, the Cl-900 detected only a slight increase in the ethylene concentration when the ethylene was delivered to the electrochemical cell sensor in the presence of the ethanol gas (triangles). The Cl-900 has a 10 ppb sensor resolution. Without the gas trap, the Cl-900 exceeded its 20 ppm upper detection limit, and thus the observed increase represents <10% of the expected increase in the “pseudo-ethylene concentration” that is typically observed when ethanol is added to the air sample. When both ethanol and isoamyl acetate were added to the air sample (shown as x's in FIG. 4), the electrochemical cell sensor showed <25% of the expected increase in the “pseudo-ethylene concentration” that is typically observed when both ethanol and isoamyl acetate are added to the air sample. The measurements were repeated twice, for three consecutive measurement periods with cyclic regeneration of the trap between measurement periods.

This Example demonstrates that the use of a cyclic trap for interfering gasses dramatically reduces the erroneous signals generated in the presence of interfering gases.

### Example 2

### Use of the Gas Trap with a Cl-900 Electrochemical Cell

This Example illustrates the use of a gas trap to remove interfering gases with a Cl-900 electrochemical cell. There is much to learn about the many roles of ethylene in the life cycle or phenology of plants. The Cl-900 ethylene analyzer offers a convenient means of collecting ethylene data in the field, and the Cl-900-FK field kit allows researchers to isolate a single flower fruit or other living or in-situ plant structure to analyze gas exchanges.

Using the high-resolution CO₂ (0-2000 ppmv) sensor, it is possible to simultaneously analyze photosynthesis and ethylene production. In various embodiments, a gas trap as described herein may be mounted upstream of the CL-900 sensor such that the incoming air samples pass through the gas trap prior to entering the electrochemical sensor. In various embodiments, this may enable the user to remove interfering gases from the air sample before they enter the electrochemical cell. In various embodiments, using the gas trap to pre-filter the air sample may dramatically increase the selectivity, sensitivity, and accuracy of the ethylene sensor.

### Example 3

### Use of the Gas Trap with a Cl-900 Electrochemical Cell in a Produce Handling or Storage Environment

This Example illustrates the use of a sensor having a gas trap as described herein in a produce storage or handling facility. Produce handlers, including growers, packers, brokers, and transporters, each deal with at least limited storage of produce. As soon as a crop is picked, the clock begins ticking towards optimal ripeness, and eventually to spoilage. Many types of produce respond drastically to temperature and to the ethylene concentration in the air surrounding them. In various embodiments, by managing these variables, the clock can be slowed, increasing the quality of the fruit that eventually leaves that temporary storage. In various embodiments, the longer the fruit remains in storage, the greater the opportunity to improve quality. Further, if the fruit can be stored for a longer period without ill effects, the seller may have more leverage over market prices. Thus, in various embodiments, the use of ethylene management techniques can be tied directly to profitability.

In some embodiments, a produce broker may manage several rooms or buildings full of fruits and vegetables. In these scenarios, a Cl-900 electrochemical cell ethylene sensor equipped with a gas trap pre-filter as described herein may be used to determine whether ethylene is contributing significantly to premature ripening of various types of fruit. In some embodiments, the Cl-900 electrochemical cell may be placed near or amongst the fruit being studied. In various embodiments, the device may then be turned on and allowed to run for an hour, a day, a week, or more in continuous operation. In various embodiments, the internal battery may last for up to about 4 hours, and beyond that, a power adapter may be used. In some embodiments, ethylene generating events may be cyclical, for example occurring daily or weekly, so a longer ethylene monitoring period may be preferred. Data may be streamed wirelessly to a computing device or collected on local media, such as an SD card, and may then be analyzed. In some embodiments, any increases in ethylene may be correlated to simultaneous activities that may be altered to minimize their ethylene contributions.

### Example 4

### Use of the Gas Trap with a Cl-900 Electrochemical Cell in a Fixed Installation

This Example illustrates the use of a sensor having a gas trap as described herein in a permanent installation. In some embodiments, a Cl-900 electrochemical cell ethylene sensor equipped with a gas trap pre-filter as described herein may be installed in a fixed location, plugged into a power outlet, and used to monitor a space over a long term. In various embodiments, controlling atmospheric conditions for fruit storage may include managing CO₂ and oxygen, as well as ethylene levels in the environment. In some embodiments, a low-resolution CO₂ sensor (0-10,000 ppmv) and an oxygen sensor may be incorporated into or used in conjunction with the Cl-900 ethylene sensor. In various embodiments, ethylene levels, CO₂ levels, and O₂ levels may be minimized, and temperatures may be maintained at a level just above or below freezing. In some embodiments, a terminal block at the back side of the Cl-900 electrochemical cell may be used to trigger various air handling equipment or alarms at user configurable ethylene thresholds. In some embodiments, other pins on the terminal block may feed sensor readings to other larger air handling system controllers.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An ethylene sensor comprising:
an electrochemical cell; and
a polar solvent gas trap pre-filter, wherein the gas trap is positioned upstream of the electrochemical cell.

2. The ethylene sensor of claim 1, wherein the polar solvent captures one or more interfering gases.

3. The ethylene sensor of claim 2, wherein the one or more interfering gases comprise ethanol, methanol, carbon monoxide, or isoamyl acetate.

4. The ethylene sensor of claim 3, wherein the polar solvent allows ethylene to pass through the gas trap.

5. The ethylene sensor of claim 1, wherein the polar solvent comprises water or an alcohol.

6. The ethylene sensor of claim 1, wherein the ethylene sensor is configured to pass an air sample through the gas trap before passing the air sample into the electrochemical cell.

7. The ethylene sensor of claim 1, further comprising a circulator to circulate an air sample through the gas trap and the electrochemical cell.

8. The ethylene sensor of claim 7, wherein the circulator has a forward mode and a reverse mode.

9. The ethylene sensor of claim 8, wherein operating the circulator in the forward mode moves an air sample through the gas trap and into the electrochemical cell.

10. The ethylene sensor of claim 9, wherein operating the circulator in the reverse mode regenerates the gas trap after use.

11. A method of measuring an ethylene level in an air sample, the method comprising:
passing the air sample by through a polar solvent gas trap; and
measuring the ethylene level in the air sample with an electrochemical cell.

12. The method of claim 11, wherein passing the air sample through the polar solvent gas trap allows the polar solvent to capture one or more interfering gases.

13. The method of claim 12, wherein the one or more interfering gases comprise ethanol, methanol, carbon monoxide, or isoamyl acetate.

14. The ethylene sensor of claim 13, wherein passing the air sample through the polar solvent gas trap allows ethylene to pass through the gas trap.

15. The method of claim 11, wherein the polar solvent comprises water or an alcohol.

16. The method of claim 11, wherein passing the air sample through the polar solvent gas trap comprises using a circulator to circulate the air sample through the gas trap and into the electrochemical cell.

17. The method of claim 16, wherein the circulator has a forward mode and a reverse mode.

18. The ethylene sensor of claim 17, wherein operating the circulator in the forward mode moves an air sample through the gas trap and into the electrochemical cell.

19. The ethylene sensor of claim 18, wherein operating the circulator in the reverse mode regenerates the gas trap after use.

20. The method of claim 16, wherein the method further comprises operating the circulator in the reverse mode to regenerate the gas trap.
